(19) United States
(12) Patent Application Publication
(10) Pub. No.: US 2026/0126245 A1
(43) Pub. Date: May 7, 2026

(54) SYSTEMS AND METHODS FOR ALIGNING SEQUENCES TO PERSONALIZED REFERENCES

(71) Applicant: Seven Bridges Genomics Inc., Charlestown, MA (US)

(72) Inventors: Yongan Zhao, Darien, IL (US); Wan-Ping Lee, Somerville, MA (US)

(73) Assignee: Seven Bridges Genomics Inc., Charlestown, MA (US)

(21) Appl. No.: 19/352,014

(22) Filed: Oct. 7, 2025

Related U.S. Application Data
(63) Continuation of application No. 15/809,229, filed on Nov. 10, 2017, now abandoned.
(60) Provisional application No. 62/420,585, filed on Nov. 11, 2016.

(51) Int. Cl. F25J 1/00; F25J 1/02; G05B 1/03; G05B 6/02

(52) U.S. Cl. CPC F25J 1/0022; F25J 1/004; F25J 1/0052; F25J 1/0055; F25J 1/0072; F25J 1/0082; F25J 1/0087; F25J 1/0214; F25J 1/0216; F25J 1/0244; F25J 1/0252; F25J 1/0257; F25J 1/0292; G05B 1/03; G05B 6/02

(57) ABSTRACT

Techniques for generating a personalized reference sequence construct for an individual to align sequence reads obtained for the individual. The techniques include: obtaining a plurality of sequence reads for an individual; obtaining information identifying a plurality of locations; genotyping the plurality of sequence reads for the plurality of locations to obtain a first set of variants for the individual for at least some of the plurality of locations; identifying a second set of variants associated with the first set of variants; generating a personalized reference sequence construct using the second set of variants; and aligning the plurality of sequence reads to the personalized reference sequence construct.

### CROSS-REFERENCE TO RELATED APPLICATIONS

This application claims priority from U.S. Provisional Patent Application Ser. No. 62/420,585, filed on Nov. 11, 2016, entitled “SYSTEMS AND METHODS FOR ALIGNING SEQUENCES TO PERSONALIZED REFERENCES”, which is hereby incorporated by reference.

### FIELD

Aspects of the technology described herein relates to systems and methods for generating personalized reference constructs and aligning sequence reads to the generated personalized reference constructs.

### BACKGROUND

Advances in sequencing technology, including the development of next generation sequencing methods, have made sequencing an important tool used both in research and in medicine. Some applications of sequencing technology include aligning the sequence reads obtained by sequencing techniques against a reference sequence construct, and identifying the differences, sometimes termed “variants,” between the sequence reads and the reference sequence construct. In turn, the identified differences may be used for diagnostic, therapeutic, research, and/or other purposes.

There are different types of reference sequence constructs to which sequence reads may be aligned. For example, sequence reads may be aligned against a linear reference sequence construct such as, for example, the hg19 or hg38 human reference genomes. As another example, sequence reads may be aligned against a reference sequence construct that accounts for one or more known variants at one or more respective locations. One example of such a reference sequence construct is a graph-based reference sequence construct (sometimes referred to herein as a “graph reference”). A graph reference may include a graph (e.g., a directed acyclic graph) through which there may be multiple paths, each of which may represent one or multiple known variants.

### SUMMARY

Some embodiments are directed to a system, comprising: at least one hardware processor; and at least one non-transitory computer-readable storage medium storing processor-executable instructions that, when executed by the at least one hardware processor, cause the at least one hardware processor to perform: obtaining a plurality of sequence reads for an individual; obtaining information identifying a plurality of locations; genotyping the plurality of sequence reads for the plurality of locations to obtain a first set of variants for the individual for at least some of the plurality of locations; identifying a second set of variants associated with the first set of variants; generating a personalized reference sequence construct using the second set of variants; and aligning the plurality of sequence reads to the personalized reference sequence construct.

Some embodiments are directed to at least one non-transitory computer-readable storage medium storing processor-executable instructions that, when executed by at least one hardware processor, cause the at least one hardware processor to perform: obtaining a plurality of sequence reads for an individual; obtaining information identifying a plurality of locations; genotyping the plurality of sequence reads for the plurality of locations to obtain a first set of variants for the individual for at least some of the plurality of locations; identifying a second set of variants associated with the first set of variants; generating a personalized reference sequence construct using the second set of variants; and aligning the plurality of sequence reads to the personalized reference sequence construct.

Some embodiments are directed to a method, comprising: using at least one hardware processor to perform: obtaining a plurality of sequence reads for an individual; obtaining information identifying a plurality of locations; genotyping the plurality of sequence reads for the plurality of locations to obtain a first set of variants for the individual for at least some of the plurality of locations; identifying a second set of variants associated with the first set of variants; generating a personalized reference sequence construct using the second set of variants; and aligning the plurality of sequence reads to the personalized reference sequence construct.

Some embodiments are directed to a system, comprising at least one hardware processor; and at least one non-transitory computer-readable storage medium storing processor-executable instructions that, when executed by the at least one hardware processor, cause the at least one hardware processor to perform: obtaining a plurality of sequence reads for an individual; obtaining information identifying a plurality of locations and information about variant occurrence at the plurality of locations for each of at least some of a plurality of subpopulations; genotyping the plurality of sequence reads for the plurality of locations; identifying, using results of the genotyping and the information about variant occurrence, at least one subpopulation in the plurality of subpopulations to which the individual likely belongs; generating a personalized reference sequence construct based, at least in part, on the at least one identified subpopulation; and aligning the plurality of sequence reads to the personalized reference sequence construct.

Some embodiments are directed to at least one non-transitory computer-readable storage medium storing processor-executable instructions that, when executed by at least one hardware processor, cause the at least one hardware processor to perform: obtaining a plurality of sequence reads for an individual; obtaining information identifying a plurality of locations and information about variant occurrence at the plurality of locations for each of at least some of a plurality of subpopulations; genotyping the plurality of sequence reads for the plurality of locations; identifying, using results of the genotyping and the information about variant occurrence, at least one subpopulation in the plurality of subpopulations to which the individual likely belongs; generating a personalized reference sequence construct based, at least in part, on the at least one identified subpopulation; and aligning the plurality of sequence reads to the personalized reference sequence construct.

Some embodiments are directed to a method comprising using at least one hardware processor to perform: obtaining a plurality of sequence reads for an individual; obtaining information identifying a plurality of locations and information about variant occurrence at the plurality of locations for each of at least some of a plurality of subpopulations; genotyping the plurality of sequence reads for the plurality of locations; identifying, using results of the genotyping and the information about variant occurrence, at least one subpopulation in the plurality of subpopulations to which the individual likely belongs; generating a personalized reference sequence construct based, at least in part, on the at least one identified subpopulation; and aligning the plurality of sequence reads to the personalized reference sequence construct.

### BRIEF DESCRIPTION OF DRAWINGS

Various aspects and embodiments will be described with reference to the following figures. The figures are not necessarily drawn to scale.

FIG. 1 is an illustrative diagram of a graph-based reference sequence construct, in accordance with some embodiments of the technology described herein.

FIG. 2 is a flowchart of an illustrative process for generating a personalized reference sequence construct for an individual and aligning sequence reads of the individual to the generated personalized reference sequence construct, in accordance with some embodiments of the technology described herein.

FIG. 3A is a diagram illustrating a fast genotyping technique based on masking regions of a reference construct, in accordance with some embodiments of the technology described herein.

FIG. 3B is a diagram illustrating a fast genotyping technique using k-mers, in accordance with some embodiments of the technology described herein.

FIG. 4 is a flowchart of an illustrative process for generating a model for identifying the subpopulation(s) to which an individual likely belongs, in accordance with some embodiments of the technology described herein.

FIG. 5A shows a table illustrating five clusters, corresponding to respective subpopulations, obtained by applying the ADMIXTURE clustering technique to the European (EUR) data set from the 1000 Genomes project, in accordance with some embodiments of the technology described herein.

FIG. 5B shows a table illustrating four clusters, corresponding to respective subpopulations, obtained by applying the ADMIXTURE clustering technique to the European (EUR) data set from the 1000 Genomes project, in accordance with some embodiments of the technology described herein.

FIG. 6 is a block diagram of an illustrative computer system that may be used in implementing some embodiments of the technology described herein.

### DETAILED DESCRIPTION

Aligning sequence reads against a graph reference, which accounts for known genetic variations among people, aids accurate placement of sequence reads and facilitates identification of variants based on results of the alignment. However, the inventors have recognized and appreciated that conventional techniques for aligning sequence reads against graph references may be improved upon because they are computationally expensive and may produce inaccurate results due to the complexity of the underlying graphs.

Alignment of sequence reads to a graph reference may be computationally expensive to perform when the graph reference incorporates many variants from many different individuals. Since a known variant in a graph reference may be represented by a respective path through the graph underlying the graph reference, increasing the number of known variants represented by a graph reference increases the number of paths through the graph that have to be evaluated during alignment of sequence reads to the graph reference, which in turn increases the computational complexity of performing the alignment. Moreover, the added complexity in the structure of the graph reference may result in noise during alignment, reducing accuracy.

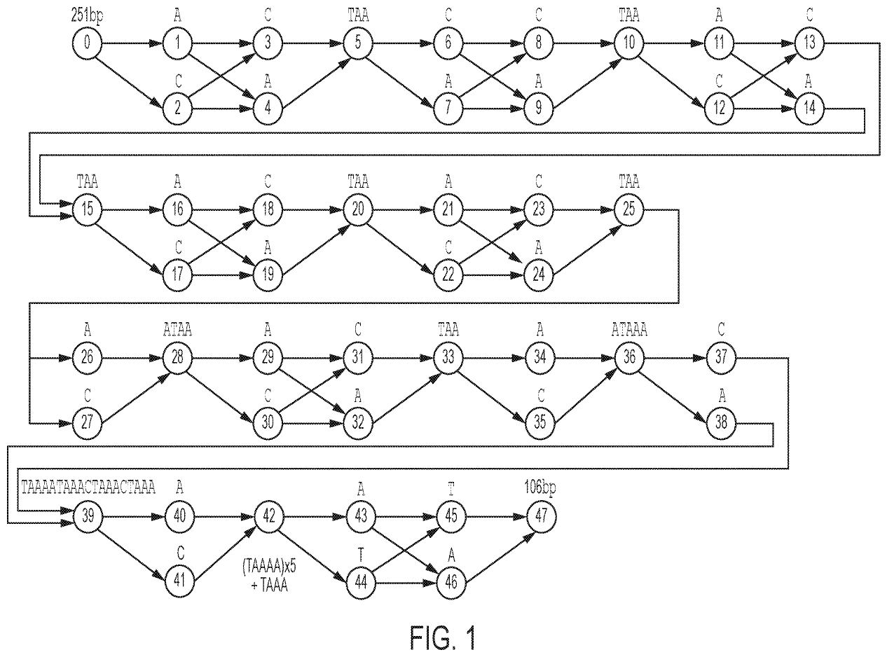

For example, the 1000 Genomes Project performed whole-genome sequencing of a geographically diverse set of 2,504 individuals, yielding a broad spectrum of genetic variation including over 88 million known variants. Incorporating all of these variants into a single graph reference yields regions of the graph that include a very large number of paths (reflecting significant variation in corresponding regions of the human genome) and, as a result, it is computationally expensive to align sequence reads to such regions. For instance, FIG. 1 shows an illustrative portion of a graph reference incorporating known variants in a particular region of chromosome 1 of the human genome. There are many known variants in this region, which is reflected in the large number of paths through the illustrated portion of the graph reference. In particular, the illustrated portion of the graph reference includes 48 nodes and approximately 262,000 (more than a quarter million!) possible paths. Aligning sequence reads to a graph reference representing variation in this region may require evaluating each of the 262,000 paths, which can be a significant impediment to alignment speed. Indeed, aligning a single sequence read to this region may take an hour, which is prohibitively expensive and makes aligning to a graph reference impractical even though the results of such an alignment may be useful.

Some embodiments described herein address all of the above-described issues that the inventors have recognized with conventional techniques for aligning sequence reads to a graph reference. However, not every embodiment described herein addresses every one of these issues, and some embodiments may not address any of them. As such, it should be appreciated that embodiments of the technology described herein are not limited to addressing all or any of the above-discussed issues of conventional techniques for aligning sequence reads to a graph reference.

The inventors have developed techniques for aligning sequence reads to a graph reference that reduce the overall computational complexity of performing such an alignment, and not only lead to a decrease in the time required to perform the alignment, but also to an increase in its accuracy. In some embodiments, rather than aligning sequence reads for an individual to a graph reference that incorporates all known variations, a customized or personalized graph reference construct is generated for the individual based on results of a fast genotyping step performed on the sequence reads to be aligned. The sequence reads for the individual are then aligned to the personalized reference construct.

In some embodiments, the personalized graph reference construct for an individual may contain only those variants that are likely to be observed in the individual rather than all possible variants that may be observed in any individual. As a result, the number of variants represented by (and the number of paths through) a personalized graph reference construct (sometimes referred to herein as a “personalized graph reference”) is smaller than the number of variants represented by a graph reference that simply incorporates all known variants (e.g., all the variants uncovered by the 1000 Genomes Project). Consequently, aligning the sequence reads for an individual against a personalized graph reference is less computationally expensive than aligning the same sequence reads against a graph reference that incorporates all known variants.

In some embodiments, the determination of which variants are likely to be observed in an individual may be made by: (1) identifying one or more groups of people to which the individual likely belongs; and (2) identifying the variants associated with (e.g., commonly observed) in the identified group(s) of people. In turn, the variants associated with the identified group(s) may be used to construct the personalized graph reference, for example, by adding nodes and edges representing the identified variants to a linear reference construct.

In some embodiments, the groups of people may be subpopulations of people identified based on common genetic ancestry. Examples of such subpopulations are provided herein. In such embodiments, a personalized graph reference for an individual may be constructed by: (1) obtaining sequence reads for the individual; (2) genotyping the sequence reads at a set of “informative” locations and using the results of the genotyping to identify one or more subpopulations to which the individual likely belongs; (3) identifying variants associated with the determined subpopulation(s); and (4) constructing a personalized graph reference using the identified variants. The sequence reads for the individual may then be aligned against the constructed personalized graph reference using any suitable technique for aligning sequence reads against a graph reference including any of the techniques described in U.S. Patent Publication No. 2015-0057946, entitled “METHODS AND SYSTEMS FOR ALIGNING SEQUENCES,” published on Feb. 26, 2015, which is incorporated by reference herein in its entirety.

It should be appreciated that the determination of which variants are likely to be observed in an individual is not limited to being performed by identifying subpopulation(s) to which an individual belongs. For example, in some embodiments, results of a fast genotyping step performed on sequence reads of the individual may be used to identify any other type of group to which the individual may belong (e.g., a group of people having a same medical condition such as a same type of cancer, a group of people living in similar environmental conditions, and a group of people likely having similar variants for any other suitable reason(s)). As another example, in some embodiments, results of a fast genotyping step performed on sequence reads of the individual may be used to identify a first set of variants. One or more databases may be then used to identify a second set of variants associated (e.g., correlated) with the first set of variants (e.g., by identifying variants that sufficiently frequently co-occur with one or more variants in the first set of variants). In turn, the second set of variants may be used to construct a personalized graph reference.

In some embodiments, a personalized reference sequence construct for an individual may be generated by: (1) obtaining sequence reads for the individual; (2) obtaining information identifying locations (e.g., less than 100K locations, less than 1 million locations) for which to genotype the obtained sequence reads; (3) genotyping the sequence reads for the identified locations to obtain a first set of variants for the individual for at least some of the locations; (4) identifying a second set of variants associated with the first set of variants; and (5) generating the personalized reference sequence construct for the individual by using the second set of variants. In turn, the sequence reads for the individual may be aligned to the generated personalized reference sequence construct.

In some embodiments, identifying the second set of variants associated with the first set of variants may include identifying one or more variants correlated with variants in the first set of variants. This may be done in any suitable way. For example, one or more databases of variant occurrence may be used to determine which variants co-occur with variants in the first set of variants sufficiently frequently (e.g., at least a threshold number of times). In some embodiments, variant co-occurrence statistics may be computed in advance so that, once the first set of variants for an individual are determined, a second set of variants correlated with the first set of variants may be quickly identified.

In some embodiments, identifying the second set of variants may comprise: (1) accessing a model for identifying one or more subpopulations in a plurality of subpopulations to which the individual likely belongs; (2) identifying, using the first set of variants and the model, a first subpopulation in the plurality of subpopulations to which the individual likely belongs; and (3) identifying the second set of variants as variants associated with the first subpopulation.

In some embodiments, it may be determined that it is likely that an individual may belong to any of one or more of multiple subpopulations. In such instances, the personalized graph reference for the individual may be constructed from variants associated with each of the subpopulations to which the individual may likely belong. For example, it may be determined that an individual may likely belong to a first subpopulation, a second subpopulation, or both the first and second subpopulations. In this example, the personalized graph reference may be generated using a set of variants associated with the first subpopulation and another set of variants associated with the second subpopulation.

In some embodiments, the model for identifying one or more subpopulations in a plurality of subpopulations to which the individual likely belongs may include information indicating subpopulation-specific variant occurrence frequencies for the particular locations at which genotyping is to be performed to identify the subpopulation(s) to which the individual likely belongs. In turn, the first set of variants (obtained by genotyping sequence reads for the individual at the particular locations) for the individual may be compared with the subpopulation-specific variant occurrence frequencies to identify which of the plurality of subpopulations to which the individual likely belongs. For example, the model may indicate that certain variants at particular locations may occur more frequently in subpopulation A than in subpopulation B. If genotyping the sequence reads of the individual at the particular locations were to reveal that the individual has these certain variants, the model may be used to infer (and, in some embodiments, quantify the likelihood or probability) that it is more likely that the individual belongs to subpopulation A than to subpopulation B.

As may be appreciated from the foregoing, results of genotyping the sequence reads at a particular set of locations may be used to identify one or more sub-populations to which an individual belongs. A number of different techniques may be used to perform this genotyping step, as described below. Regardless of which technique is used, however, the goal of any technique used to perform the genotyping step is to identify the likely sub-population(s) as quickly as possible (which is why this genotyping step is sometimes referred to as “fast genotyping” herein) so that the overall alignment process is not delayed due to this step. Accordingly, in some embodiments, this fast genotyping step is performed without doing a full alignment of all the sequence reads. Rather, the sequence reads may be aligned and genotyping may be performed for only for those locations at which genotype information is useful for discriminating among the different subpopulations and/or groups to which an individual may belong. For instance, it would not be helpful to determine whether an individual has a variant at a location where the same proportion (e.g., none, some, or all) individuals in all subpopulations have the same variant-knowing that the individual has a variant at that location would not help determine the subpopulation(s) to which the individual likely belongs. Such a location is “non-informative” with respect to identifying the subpopulation(s) to which the individual likely belongs. On the other hand, it may be helpful to determine that an individual has a variant at a particular location, when the percentage of individuals in one sub-population that has the variant at the particular location is different from the percentage of individuals in another subpopulation. Such a location may be referred to herein as an “informative” location.

In some embodiments, genotyping the sequence reads for the locations to obtain a first set of variants for the individual may be performed using a reference construct different from the personalized reference construct that is subsequently used to align all the sequence reads for the individual. For example, the reference construct used as part of the fast genotyping step may be a linear reference sequence (e.g., the hg19 or hg38 genome references), whereas the personalized reference sequence construct may be a graph reference or other type of reference construct.

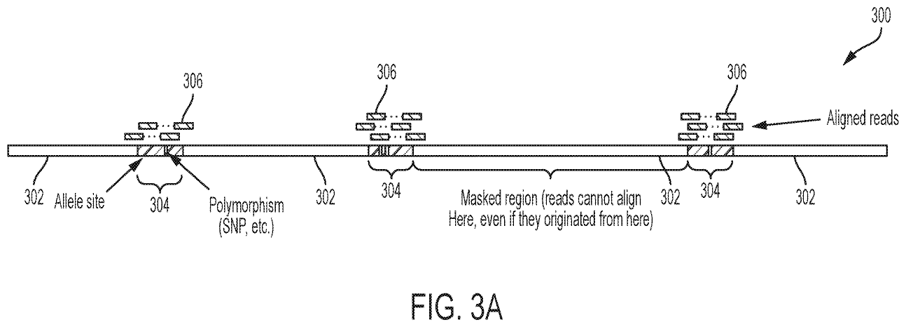

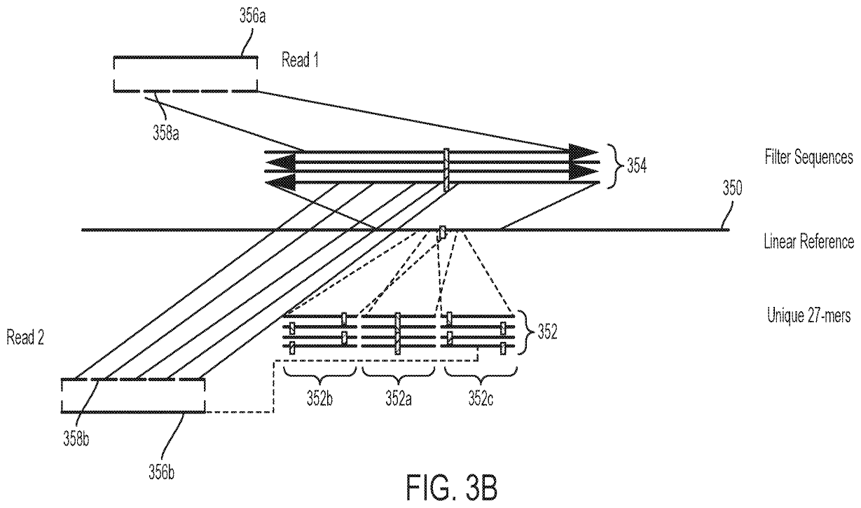

In some embodiments, the reference construct used for the genotyping step may be a linear reference sequence, and the genotyping may be performed by a masking approach that includes: (1) identifying a set of locations (to be masked) in the linear reference sequence; and (2) aligning the sequence reads to locations in the linear reference sequences that are not in the identified set of locations. As such, portions of the linear reference sequence may be masked (e.g., the portions that may not be informative or helpful with respect to identifying the subpopulation(s) to which an individual belongs) and the sequence reads may be aligned to the unmasked portion of the linear reference sequence. This is described in more detail below including with reference to FIG. 3A.

In some embodiments, the reference construct used for the genotyping step may include multiple sets of alternative sequences (e.g., multiple sets of k-mers, where a k-mer is a sequence of length k), with each of the multiple sets of alternative sequences corresponding to a respective subpopulation in the plurality of subpopulations, and wherein the genotyping comprises comparing the sequence reads for an individual to sequences in each of the sets of alternative sequences. Based on results of the comparison, at least one set of alternative sequences that best matches the sequences reads for an individual may be identified and the subpopulation(s) corresponding to the at least one set of alternative sequences may be identified as the subpopulation to which the individual likely belongs.

In some embodiments, the personalized reference sequence construct may be a personalized graph reference. The personalized graph reference may include a directed acyclic graph (DAG) through which there are multiple paths. In such embodiments, generating the personalized reference sequence construct may include: (1) obtaining an initial reference sequence construct; and (2) updating the initial reference sequence construct to reflect variants in the second set of variants. This second set of variants being identified based on a first set of variants determined for the individual by genotyping the individual's sequence reads at select locations.

In some embodiments, the initial reference sequence construct may include a linear reference sequence and updating the initial reference sequence construct may include generating a directed acyclic graph by transforming the linear reference sequence into an initial graph and adding nodes and edges to the initial graph to obtain a directed acyclic graph reflecting the linear reference sequence and the second set of variants. In some embodiments, the initial reference sequence construct may include a linear reference sequence, and updating the initial reference sequence construct may include adding, to the initial reference sequence construct, a set of one or more alternative sequences reflecting the second set of variants.

Some embodiments are directed to generating a model for identifying the subpopulation(s) to which an individual likely belongs. Generating the model may include: (1) obtaining a plurality of subpopulations by applying statistical analysis to genomic data; (2) determining information indicating subpopulation-specific variant frequencies for each of the plurality of subpopulations; (3) refining the information indicating the subpopulation-specific variant frequencies; (4) identifying “informative” locations at which frequencies of variant occurrence vary among at least some of the subpopulations; and (5) generating the model for identifying subpopulations to which an individual likely belongs based on the identified subpopulations, identified locations, and frequencies of variant occurrence.

As used herein, the term “population” may refer to groups of people exhibiting commonalities in genetic makeup. Commonalities in genetic makeup of a population of people may arise for any of a variety of reasons. For example, commonalities in genetic makeup of a population of people may result from people in the population having similar ancestral patterns of breeding and/or migration. For instance, one set of populations identified by the 1000 Genomes project includes the following (so-called “continental”) populations: (1) a population of people having African ancestry (abbreviated as the “AFR” population); (2) a population of people having Native American ancestry (abbreviated as the “AMR” population); (3) a population of people having East Asian ancestry (abbreviated as the “EAS” population); (4) a population of people having European ancestry (abbreviated as the “EUR” population); and (5) a population of people having South Asian Ancestry (abbreviated as the “SAS” population). As another example, commonalities in genetic makeup of a population of people may result from people in the population having similar genetic mutations caused by an underlying disease (e.g., the population of people having breast cancer, the population of people having sickle cell anemia, the population of people having cystic fibrosis).

Sub-groups of a population may be referred to, herein, as subpopulations. For example, each of the continental populations (i.e., AFR, AMR, EAS, EUR, and SAS populations) identified by the 1000 Genomes project may include multiple sub-populations. Such sub-populations may be identified in any of a variety of ways. For example, the 1000 Genomes project utilized a number of subpopulations of each of the continental populations (for a total of 26 subpopulations), which are detailed below. It should be appreciated, however, that each of the continental populations may include one or more additional subpopulations (e.g., subpopulations not utilized as part of the 1000 Genomes project). It should also be appreciated, that the manner in which people were grouped into populations and subpopulations as part of the 1000 Genomes project is but one way to group people into populations and subpopulations. Accordingly, in some embodiments, people may be clustered into the populations and subpopulations used in the 1000 Genomes project, while in other embodiments, people may be clustered into populations and subpopulations in any other suitable way and the resulting populations and/or subpopulations may be different from those identified as part of the 1000 Genomes project. Accordingly, it should be appreciated that the populations and subpopulations used by the 1000 Genomes project are presented here by way of example and not limitation.

According to the 1000 Genomes project, people in the AFR population may include the following seven subpopulations of people: (1) the Esan subpopulation (“ESN”); (2) the Gambian subpopulation (“GWD”); (3) the Luhya subpopulation (“LWK”); (4) the Mende subpopulation (“MSL”); (5) the Yoruba subpopulation (“YRI”); (6) the Barbadian subpopulation (“ACB”); and (7) the African-American SW subpopulation (ASW). People in the AMR population may include the following four subpopulations of people: (1) the Colombian subpopulation (“CLM”); (2) the Mexican-American subpopulation (“MXL”); (3) the Peruvian subpopulation (“PEL”); and (4) the Puerto Rican subpopulation (“PUR”). People in the EAS population may include the following five subpopulations of people: (1) the Dai Chinese subpopulation (“CDX”); (2) the Han Chinese subpopulation (“CHB”); (3) the Southern Han Chinese subpopulation (“CHS”); (4) the Japanese subpopulation (“JPT”); and (5) the Kinh Vietnamese subpopulation. People in the EUR population may include the following five subpopulations of people: (1) the Utah residents with Northern and Western European ancestry subpopulation (“CEPH”); (2) the British subpopulation (“GBR”); (3) the Finnish subpopulation (“FIN”); (4) the Iberian subpopulation (“IBR”); and (5) Tuscan subpopulation (“TSI”). People in the SAS population may include the following five subpopulations of people: (1) the Bengali subpopulation (“BEB”); (2) the Gujarati subpopulation (“GIH”); (3) the Telugu subpopulation (“ITU”); (4) the Punjabi subpopulation (“PJL”); and (5) the Tamil subpopulation (“STU”).¹ It should be appreciated that the various aspects and embodiments described herein be used individually, all together, or in any combination of two or more, as the technology described herein is not limited in this respect.

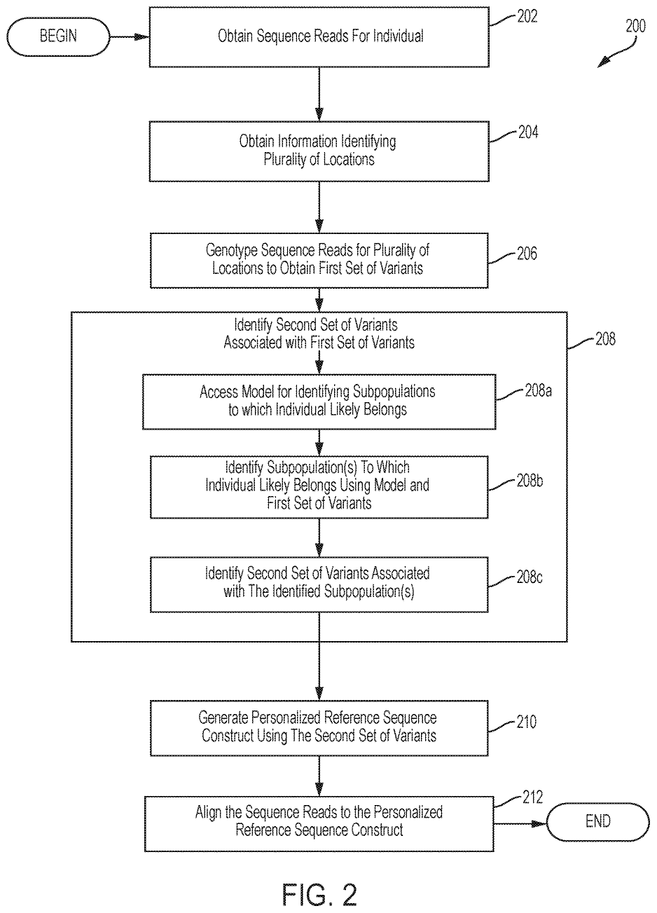

FIG. 2 is a flowchart of an illustrative process 200 for generating a personalized reference sequence construct for an individual and aligning sequence reads of the individual to the generated personalized reference sequence construct, in accordance with some embodiments of the technology described herein. Process 200 may be performed by any suitable computing device(s) (e.g., a single computing device, multiple computing devices co-located in a single physical locations or located in multiple physical locations remote from one another, one or more computing devices part of a cloud computing system, etc.), as aspects of the technology described herein are not limited in this respect.

Process 200 begins at act 202, where sequence reads for an individual are obtained. The sequence reads may be obtained by sequencing one or more biological samples obtained from the individual, for example, by using next generation sequencing and/or any other suitable sequencing technique or technology, as aspects of the technology described herein are not limited by the manner in which the sequence reads for an individual are obtained.

Next, process 200 proceeds to act 204, where information identifying a plurality of locations (allele sites) is obtained. These locations include locations for which the sequence reads obtained at act 202 are to be genotyped as part of act 206, as described below. In some embodiments, results of genotyping the sequence reads for the individual at these locations may be used to identify subpopulation(s) and/or other groups to which the individual likely belongs (e.g., as described below with reference to acts 208a, 208b, and 208c). In this sense, the locations obtained at act 204 may be considered as subpopulation “markers” because knowing whether an individual has certain variants at these sites may indicate and/or may be used to infer to subpopulation(s) and/or other group(s) to which the individual likely belongs. As such, the locations identified in the information obtained at act 204 may be referred to herein as “informative locations,” “informative sites,” or “markers.”

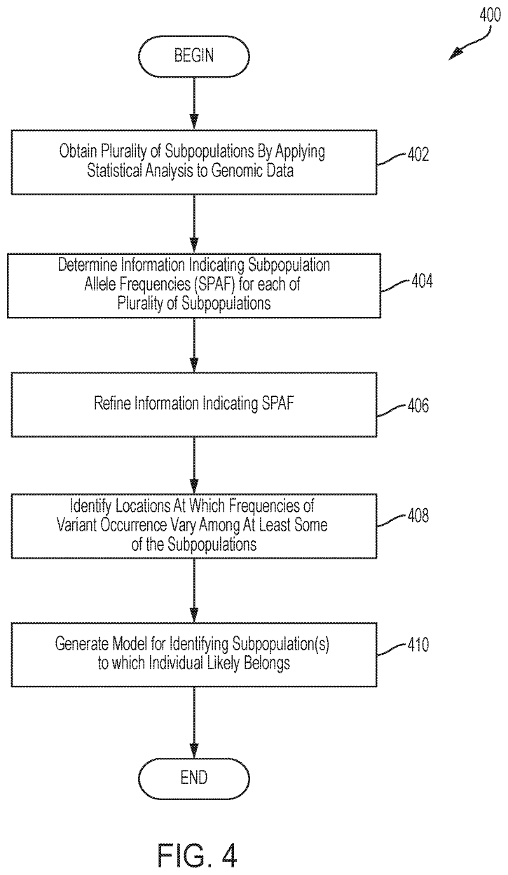

In some embodiments, obtaining information identifying the plurality of locations as part of act 204 may comprise accessing previously generated information that identifies the plurality of locations. Thus, in some embodiments, the locations may be identified prior to Additional information about subpopulations used by the 1000 Genomes project may be found at execution of process 200. In other embodiments, rather than accessing informative locations identified prior to the execution of process 200, act 204 may comprise identifying the locations as part of process 200. Techniques for identifying informative locations are described herein including with reference to FIG. 4. Thus, it should be appreciated that the locations obtained at act 204 may be either determined offline (prior to execution of process 200) or online as part of process 200.

The information obtained at act 204 may specify any suitable number of informative locations. For example, the information may specify no more than 100,000 informative locations, no more than 250,000 informative locations, no more than 500,000 informative locations, no more than 1 million informative locations, no more than 2 million informative locations, no more than 5 million informative locations, between 500,000 and two million locations, between 1 and 1.5 million locations (e.g., 1.4 million locations), or any other suitable number of locations between 100,000 and 5 million. Generally, the smaller the number of allele sites identified by the information obtained at act 204, the more quickly can the “fast” genotyping of act 206 be performed. The inventors have observed that accurate identification of subpopulation(s) to which an individual belongs may be performed based on results of genotyping the sequence reads obtained at act 202 using fewer than 100,000 informative locations, though increased accuracy may be obtained as the number of locations used during fast genotyping is increased. In some embodiments, the exact number of informative sites to use may be determined by weighing the trade-off between accuracy and speed of the fast genotyping step. Such a determination may be made on a case-by-case basis.

Next, process 200 proceeds to act 206, where the sequence reads obtained at act 202 are genotyped for at least some of the plurality of locations identified in the information obtained at act 204 to obtain a first set of variants for the individual. (These variants are termed the “first set of variants” to distinguish them from a second set of variants obtained using the first set of variants, as discussed below with reference to act 208.) In some embodiments, the first set of variants may be used to identify the subpopulation(s) and/or group(s) to which the individual likely belongs. The genotyping may be performed in any of numerous ways.

In some embodiments, the genotyping step may be performed by using a masking approach in which portions of a linear reference sequence are masked and the sequence reads are aligned to unmasked portions of the linear reference sequence. The portions of the linear reference sequence that are informative or helpful with respect to identifying the subpopulation(s) to which an individual belongs may be left unmasked. For example, the informative locations identified in the information obtained at act 204 may be left unmasked, along with short sequences to the left and right of these informative locations, and the sequence reads may be aligned to the unmasked regions of the linear reference sequence. After the sequence reads are aligned, the nucleotides of the sequence reads at the informative sites may be compared with the nucleotides at the informative sites in the linear reference sequence to identify the first set of one or more variants for the individual. FIG. 3A further illustrates this approach and shows a linear reference sequence 300 having masked regions 302 and unmasked regions 304. As shown in FIG. 3A, the sequence reads 306 may be aligned only to the unmasked regions, but not to the masked regions.

In some embodiments, the genotyping step may be performed by: (1) generating alternative sequences each of which is associated with at least one known variant (e.g., occurring in individuals in one or multiple subpopulations); and (2) comparing the sequence reads to the alternative sequences. Matches between a sequence read and an alternative sequence representing a particular variation may provide an indication that the sequence read includes the particular variation, which indications may be used to generate the first set of variants.

In some embodiments, generating alternative sequences may be performed by using information indicating variants occurring, in individuals in each of one or multiple subpopulations, at the locations identified by the information obtained at act 204. In some embodiments, at least one alternative sequence may be generated for each of one or more such variants. For example, in some embodiments, the information obtained at act 204 may identify multiple locations at which to genotype the sequence reads including a particular location “V1” having a reference allele “A”. Additional information may be accessed indicating that individuals in one or more subpopulations also have two non-reference alleles “C” or “T” at the location V1. Then, alternative sequences may be generated for the reference allele “A”, non-reference allele “C”, and non-reference allele “T” for the location “V1.”

In some embodiments, an alternative sequence may be a sequence of length k (a “k-mer”) and may be associated with a particular variant v. For example, let v represent a known variant (e.g., a substitution) centered at a particular position p, and let k₀rk₁ represent the reference sequence (e.g., from the hg38 human genome) centered on position p of the SNP v, with r representing the reference sequence for the substitution v, k₀ representing a subsequence in the reference sequence to the left of r, and k₁ representing a subsequence in the reference sequence to the right of r. Then an alternative sequence reflecting the particular variant v may be generated as the sequence k₀vk₁. This alternative sequence includes the variant v, i.e., a non-reference allele observed at that position in the reference sequence. Additionally, one or more other alternative sequences may be generated including the sequence k₀rk₁, which includes the reference nucleotide(s) at the site of the variant, the reverse complement of the sequence k₀vk₁, and/or the reverse complement of the sequence k₀rk₁. Thus, in some embodiments, four alternative sequences may be generated for each particular known variant. Each of these sequences may be said to represent and/or be associated with the variant v.

As may be appreciated from the foregoing example, an alternative sequence for a variant may be centered at the position of the variant (e.g., so that the left subsequence k₀ and the right portion k₁ are of the same length), though this is not a limitation of aspects of the technology described herein because, in some embodiments, one or more alternative sequences that are not centered at the variant site may be generated in addition to or instead of the alternative sequences that are centered at the position of the variant. Accordingly, in some embodiments one or more (e.g., four: variant sequence of length k, reference sequence of length k, and reverse complements thereof) alternative sequences that are centered on a variant site may be generated and/or one or more alternative sequences that are not centered on the variant site may be generated. For example, in some embodiments, a set of alternative sequences may be generated that is centered on the variant site, another set of alternative sequences may be generated for which the variant site is located in the beginning portion of the alternative sequences, and yet another set of alternative sequences may be generated for which the variant site is located toward the end of the alternative sequences. Such an embodiment is illustrated in FIG. 3B, where the set of alternative sequences 352 includes a set of four alternative sequences 352a centered on a variant site, a set of alternative sequences 352b that includes the same variant site toward the end, and another set of alternative sequences 352c that includes the same variant site toward the beginning. As yet another example, in some embodiments, an alternative sequence may be generated for every possible k-mer that includes the variant site. Although generating more alternative sequences may increase the computational complexity of performing a fast genotyping step, using a greater number of alternative sequences may increase the accuracy of fast genotyping because using a greater number of alternative sequences would make the technique more robust to sequence read errors. Additionally, when there is more than one known variant occurring at position p (e.g., v₁, V₂, or v₃,.), one or more alternative sequences may be generated for each of one or more (e.g., all) of the known variants (e.g., k₀v₁k₁, k₀v₂k₁, k₀v₃k₁, their complements, etc.).

In some embodiments, an alternative sequence may be generated for each known variant, in each of one or more subpopulations of individuals (e.g., each of the subpopulations identified as described below with reference to FIG. 4 or in any other suitable way), for each of at least some (e.g., all) of the locations identified in the information obtained at act 204. In this way, alternative sequences may be generated for use in fast genotyping of the sequence reads of the individual (obtained at act 202) at the informative sites (indicated by the information obtained at act 204) for which the determined genotypes may be used to infer to subpopulation(s) and/or other group(s) to which the individual likely belongs.

In turn, the sequence reads obtained at act 202 may be compared against sequences in the set of alternative sequences, and positive hits may be used to determine genotypes of the sequence reads at the informative sites. A sequence read may be compared to alternative sequences in any of numerous ways. For example, in some embodiments, a sequence read may be compared directly with one or more alternative sequences. As another example, a hash of a sequence read may be compared with respective hashes of each of one or more alternative sequences. As yet another example, a Burrows Wheeler Transform index of the alternative sequences may be generated and a backward search of a sequence read against the index may be performed.

The inventors have recognized that performing direct comparisons between all the sequence reads and all the alternative sequences may be computationally expensive. For example, if each of the alternative sequences were 27 nucleotides long (i.e., each of the alternative sequences is a 27-mer), comparing a 100bp sequence read to an alternative sequence would require checking every 27-mer within a 100bp read to determine whether there is a match. The computational burden of this approach may be lessened, in some embodiments, by using filter sequences to perform an initial check to determine whether a sequence read is likely to map to an informative site (e.g., to one of the locations identified in the information obtained at act 204). When it is determined that the sequence read is likely to map to an informative site, the sequence read may compared to the alternative sequence for the informative site. Otherwise, the comparison between the sequence and the alternative sequence is not performed and the associated computational expense may be avoided.

The determination of whether a sequence read is likely to map to an informative site may be made in any suitable way. In some embodiments, the determination may be made using a set of filter sequences. The set of filter sequences may be generated by generating one or multiple filter sequences for each of the informative sites. A filter sequence for an informative site may be a portion (of any suitable length) of a reference sequence that includes the reference nucleotide at the informative site and, for example, may be a portion of the reference sequence that is centered on the informative site. In some embodiments, a filter sequence may be longer (e.g., at least twice as long, at least three times as long, at least five times as long, etc.) as the length of the alternative sequences used. For example, when the alternative sequences are each 27 nucleotides long, the filter sequences may be each 150 nucleotides long. In some embodiments, multiple filter sequences for each informative site may be generated. For example, in some embodiments, four filter sequences for each informative site may be generated including: a first filter sequence that includes the variant at the position in the first filter sequence that corresponds to the site where the variant appears, a second filter sequence that includes the reference at the position in the second filter sequence that corresponds to the site where the variant appears, a third filter sequence that is a reverse complement of the first filter sequence, and a fourth filter sequence that is a reverse complement of the second filter sequence.

The initial check to determine whether a sequence read is likely to map to an informative site may then be performed by: (1) partitioning the sequence read into a number (e.g., five) of non-overlapping subsequences; (2) comparing each of the non-overlapping subsequences to the filter sequence in any suitable way (directly, using hashes, using Bloom filters, etc.); (3) determining that the sequence read is likely to map to the informative site when three or more of the non-overlapping subsequences match the filter sequence; and (4) determining that the sequence read is not likely to map to the informative site when fewer than three of the non-overlapping subsequences match the filter sequence.

For example, as illustrated in FIG. 3B, sequence reads 356a and 356b may each be partitioned into five non-overlapping segments 358a and 358b, respectively. The non-overlapping segments may be of the same or approximately the same length. The non-overlapping segments may be compared to each of one or more filter sequences 354 obtained from linear reference 350. When it is determined that at least three non-overlapping segments for a particular sequence read (e.g., portions 358a for sequence read 356a) match a filter sequence, the sequence read may be compared with a corresponding alternative sequence (a 27-mer in this example) 352. In this way, the filter sequences 354 may be used to screen the incoming sequence reads (e.g., reads 356a and 356b) as potentially informative. As shown in FIG. 3B, the filter sequences 354 include four filter sequences for each site (i.e., a reference sequence, a variant sequence, and reverse complements thereof).

In some embodiments, matching between a sequence read segment and another sequence (e.g., a filter sequence or an alternative sequence) may be performed using direct string matching, hashing, by using a Bloom filter (which is more memory efficient than a hash table, but may lead to an increase in false positives), and/or in any other suitable way.

In some embodiments, filter sequences may be used only to filter out sequence reads. However, in other embodiments, filter sequence matching information may be used to guide subsequent alternative sequence matching for those sequence reads that were not filtered out (e.g., by using information indicating the sites at which the sequence reads match the filter sequence to identify the alternative sequences to use for comparison).

Although in the above-discussed example, the length of an alternative sequence is 27 nucleotides, this is not a limitation of aspects of the technology described herein, as alternative sequences may be of any suitable length (e.g., between 15 and 35 nucleotides). For example, the alternative sequences may be the same length as the sequence reads. As another example, the alternative sequences may be shorter than the sequence reads. As yet another example, the alternative sequences may be longer than the sequence reads, so that each sequence read has to be scanned against the alternative sequence until a match is reported. This latter approach may yield positive hits for sequence reads in which the variant (e.g., the SNP) is not positioned at the center of the alternative sequence, but may require additional computation to perform the scanning.

In some embodiments, a match between a sequence read and a nucleotide sequence may be declared only when a threshold number of nucleotide matches between the sequences is identified. This may aid in accounting for the high error rates associated with next generation sequencing techniques used to obtain the sequence reads. Additionally, in some embodiments, not all the sequence reads obtained at act 202 need be compared against the alternative sequences. For example, in some embodiments, a subset of sequence reads (e.g., fewer than 50 thousand reads, fewer than 100 thousand reads, fewer than two hundred thousand reads, etc.) out of a total of millions of sequence reads (e.g., 300 million 100bp reads) may be used as part of the fast genotyping step, and the subpopulation(s) and/or group(s) to which the individual likely belongs may be used based on these sequence reads alone. In some embodiments, the number of sequence reads required may vary depending on a desired level of confidence in the called genotypes. Similarly, in some embodiments, sequence reads may be processed until a desired level of confidence is reached.

As yet another example of a technique that may be used to genotype the sequence reads obtained at act 202 at the informative sites identified in the information obtained at act 204, the lightweight assignment of variant alleles (LAVA) fast genotyping technique may be used. The LAVA technique is described in the document titled “Fast genotyping of known SNPs through approximate k-mer matching,” published in Bioinformatics (2016) vol. 32, pp. 538-544, which document is incorporated by reference in its entirety herein.

After the genotyping is performed at act 206 to obtain a first set of variants for an individual, process 200 proceeds to act 208, where a second set of variants associated with the first set of variants is identified.

In the illustrated embodiment, identifying a second set of variants includes: (1) accessing a model for identifying subpopulations to which an individual likely belongs at act 208a; (2) identifying one or more subpopulation(s) to which the individual likely belongs using the model accessed at act 208a and the first set of variants identified at act 206; and (3) identifying a second set of variants associated with the identified subpopulation(s) at act 208c. The acts 208a, 208b, and 208c are described next.

At act 208a, a model for identifying subpopulations to which an individual likely belongs may be accessed. In some embodiments, the model may be created prior to the execution of process 200, while in other embodiments, the model may be created as part of process 200. Techniques for creating a model for identifying subpopulations to which an individual likely belongs are described herein including with reference to FIG. 4.

In some embodiments, a model for identifying subpopulations to which an individual likely belongs may include information indicating subpopulation-specific variant occurrence frequencies for at least some (e.g., all) of the informative sites indicated by the information obtained at act 204. The information may be stored in any suitable format, as aspects of the technology described herein are not limited in this respect. For example, in some embodiments, the model may include an NxK matrix, where the integer N represents the number of different variants and the integer K represents the number of subpopulations. Each entry (n, k) in the NxK matrix may be a value between 0 and 1 indicating the frequency that the nth variant (e.g., a particular SNP at a particular informative site) occurs in the kth subpopulation.

Next, at act 208b, the model accessed at act 208a and the first set of variants identified at act 206 may be used to identify one or more subpopulation(s) to which the individual likely belongs. In some embodiments, the first set of variants for the individual may be compared with the subpopulation-specific variant occurrence frequencies to identify the subpopulation(s) to which the individual likely belongs. For example, the model may indicate that certain variants at informative locations may occur more frequently in subpopulation A than in subpopulation B. Accordingly, when the first set of variants obtained at act 206 includes variants that occur more frequently in subpopulation A than in subpopulation B, the model may be used to infer (and, in some embodiments, quantify the likelihood or probability) that it is more likely that the individual belongs to subpopulation A than to subpopulation B.

In some embodiments, the model and the first set of variants may be used to determine a value, for each of one or more subpopulations, indicating the likelihood that the individual belongs to the subpopulation. The value may be a likelihood, a probability or any other suitable type of value. In some embodiments, these values may be ordered and the top k most likely subpopulations to which the individual belongs may be identified. In some embodiments, only the most likely subpopulation to which the individual belongs may be determined at act 208b. In other embodiments, each subpopulation having at least a threshold likelihood of the individual belonging to the likelihood may be identified.

In some embodiments, the determination of the subpopulations to which the individual likely belongs may be performed by using a statistical software package such as ADMIXTURE, which is a software tool for maximum likelihood estimation of individual ancestries from multi-locus SNP genotype datasets. For example, the ADMIXTURE software tool may be provided with the model accessed at act 208a and the first set of variants (and/or the corresponding genotypes of the individual) identified at act 206 and, based on this input, may output the probabilities of that individual belonging to each of the subpopulations.

Next, at act 208c, a second set of variants may be obtained based on the subpopulation(s) identified at act 208b. This may be done in any suitable way. For example, all the variants occurring in the identified subpopulation(s) may be identified and included in the second set of variants. As another example, only some of the variants occurring in the identified subpopulation(s) may be identified and included in the set of variants. For instance, only variants occurring in at least a threshold number or percentage of people in at least one of the identified subpopulation(s) may be included in the second set of variants. As another example, only variants having at least a threshold subpopulation allele frequency (e.g., >0.001) may be included.

It should be appreciated that, in some embodiments, a second set of variants may be identified, at act 208, by using the first set of variants but without attempting to identify the subpopulations to which an individual belongs. In such embodiments, identifying the second set of variants associated with the first set of variants may include identifying one or more variants correlated with variants in the first set of variants. This may be done in any suitable way. For example, one or more databases of variant occurrence may be used to determine which variants co-occur with variants in the first set of variants sufficiently frequently (e.g., at least a threshold number of times). In some embodiments, variant co-occurrence statistics may be computed in advance so that, once the first set of variants for an individual are determined, a second set of variants correlated with the first set of variants may be identified quickly.

Next, process 200 proceeds to act 210, where a personalized reference sequence construct is generated using the second set of variants identified at act 208. This may be done in any suitable way. In some embodiments, for example, the personalized reference sequence construct generated at act 210 may be a personalized graph reference. The personalized graph reference may include a directed acyclic graph through which there are multiple paths, where for each variant in the second set of variants there is a corresponding path through the graph. In some embodiments, generating the personalized reference sequence construct may include: (1) obtaining an initial reference sequence construct; and (2) updating the initial reference sequence construct to reflect variants in the second set of variants. It should be appreciated that the personalized reference sequence construct is not limited to representing only the variants in the second set of variants and, additionally, may represent one or more other variants.

In some embodiments, the initial reference sequence construct may include a linear reference (e.g., the hg19 or hg38 human genome reference). The linear reference may then be transformed into a graph reference by adding nodes and edges representing genetic variation. For example, the linear reference may be transformed into a graph reference by adding nodes and edges representing the second set of variants identified at act 208 and, optionally, one or more other variants. In this way, when the second set of variants represents the variants associated with subpopulation(s) to which the individual likely belongs, the personalized graph reference will include nodes and edges representing the genetic variation that is likely to be present in the individual. It should be appreciated, however, that in some embodiments, the initial reference sequence construct may be a graph reference (rather than a linear reference) and the graph reference may be updated by adding nodes and edges representing genetic variation. Techniques for adding nodes and edges to a linear reference or a graph reference based on a set of variants are described in U.S. Patent Publication No. 2015-0057946, entitled “METHODS AND SYSTEMS FOR ALIGNING SEQUENCES,” published on Feb. 26, 2015, which is incorporated by reference herein in its entirety.

In some embodiments, the personalized graph reference may be constructed from the initial reference sequence using a layered approach. In such an approach, initially, a first set of nodes and edges may be added to the initial reference sequence to form an initial graph. The first set of nodes and edges may represent variants at allele sites that are non-informative in that they may be equally likely to be observed in many subpopulations (e.g., these variations may be those that were not found to significantly differ between populations in the chi-squared (χ²) test described below with reference to FIG. 4 when refining allele sites). Next, for each subpopulation to which the individual likely belongs (as identified at act 208b), a set of nodes and edges may be added to the initial graph thereby incorporating the variations most likely present in the subpopulation.

Next, process 200 proceeds to act 212, where the sequence reads obtained at act 202 are aligned to the personalized reference sequence construct generated at act 210. This alignment may be performed in any suitable way including any of the alignment techniques (e.g., a modified Smith-Waterman technique) described in Appendix A. Since the personalized reference sequence construct is customized to the individual by including the genetic variations most likely to be found in the individual (rather than all possible genetic variations for any person in the world), the personalized reference sequence construct is less complex than a population-scale graph and the resulting alignment will be performed faster and produce more accurate results than would be possible with the population-scale graph. For example, it may be determined using fast genotyping that an individual likely belongs to the Esan subpopulation of the continental African population, and a personalized graph reference may be constructed by incorporating variants likely to be found in people of that subpopulation. This personalized graph reference will be less complex than a population-scale graph reference incorporating all variations of the African population (e.g., including variations that appear in subpopulations other than the Esan subpopulation and do not appear in the Esan subpopulation), and aligning the individual's sequence reads to the personalized graph reference will be performed faster aligning the same reads to the population-scale graph reference.

FIG. 4 is a flowchart of an illustrative process 400 for generating a model for identifying the subpopulation(s) to which an individual likely belongs, in accordance with some embodiments of the technology described herein. Process 400 may be performed by any suitable computing device(s) (e.g., a single computing device, multiple computing devices co-located in a single physical location or located in multiple physical locations remote from one another, one or more computing devices, part of a cloud computing system, etc.), as aspects of the technology described herein are not limited in this respect.

Process 400 begins at act 402, where a plurality of subpopulations are identified by analyzing genomic data. In some embodiments, the genomic data may include genotypes for each of multiple people for a large number of loci (allele sites) at which variants (e.g., SNPs, deletions, and insertions) are known to occur, and the subpopulations may be identified applying statistical analysis techniques (e.g., multivariate statistical analysis techniques such as clustering or principal components analysis) to the genomic data. For example, the genomic data may be clustered to identify subpopulations (clusters) of people so that the (e.g., distribution of) genotypes of people within a cluster are more alike at the allele sites than the (e.g., distribution of) genotypes of people in different clusters. The genomic data may include data from any suitable number of individuals (e.g., at least 500 individuals, at least 1000 individuals, between 500 and 3000 individuals, between 1500 and 2500 individuals) for any suitable number of loci (e.g., at least 100K loci, at least 1 million loci, at least 5 million loci, between 1 and 2 million loci, between 1 and 5 million loci), as aspects of the technology described herein are not limited in this respect.

Any suitable number of subpopulations may be identified as part of act 402 of process 400. In some embodiments, the number of subpopulations may be specified in advance and the genomic data may be clustered into the specified number of clusters (with each cluster corresponding to a subpopulation). In other embodiments, the clustering technique may itself determine the number of clusters to form. In some embodiments, between 10 and 30 total subpopulations may be identified. In some embodiments, between 20 and 50 total subpopulations may be identified. In some embodiments, between 10 and 20, between 20 and 30, between 30 and 40, between 40 and 50, between 10 and 100, fewer than 25, fewer than 50, fewer than 75, or fewer than 100 subpopulations may be identified.

In some embodiments, one or more statistical software packages may be applied to the genomic data in order to identify subpopulations of people. The software packages may implement any suitable statistic technique(s) including one or more model-based statistical techniques and/or principal components analysis techniques. For example, the STRUCTURE software package (Jonathan K. Pritchard et al., Inference of Population Structure using Multilocus Genotype Data, Genetics, 164:1567-1587 (2003)), the ADMIXTURE software package (David H. Alexander et al., Fast Model-Based Estimation of Ancestry in Unrelated Individuals, Genome Research 19:1655-1664 (2009)), the FRAPPE software package (Hua Tang et al., Reconstructing genetic ancestry blocks in admixed individuals. Am J Hum Genet 79:1-12. (2006)), and/or the EIGENSTRAT software package (Principal components analysis corrects for stratification in genome-wide association studies, Nature Genetics 38(8):904-909 (2006)) may be used to identify subpopulations by applying a Bayesian clustering approach. Each of the above-identified publications is incorporated by reference herein in its entirety. This process is not done manually, which would be impossible given the large amount of genomic data to be processed.

The inventors have appreciated that, although in some instances, external information about each individual's ancestry (e.g., as self-reported by the individual, the individual's geographic location, etc.) may be used to identify subpopulations, such information may not always be reliable. Thus, although in some embodiments, such external information may be used to identify subpopulations, in other embodiments, this external information is not used and the subpopulation structure may be inferred directly from the genomic data, to the extent that such an inference is needed.

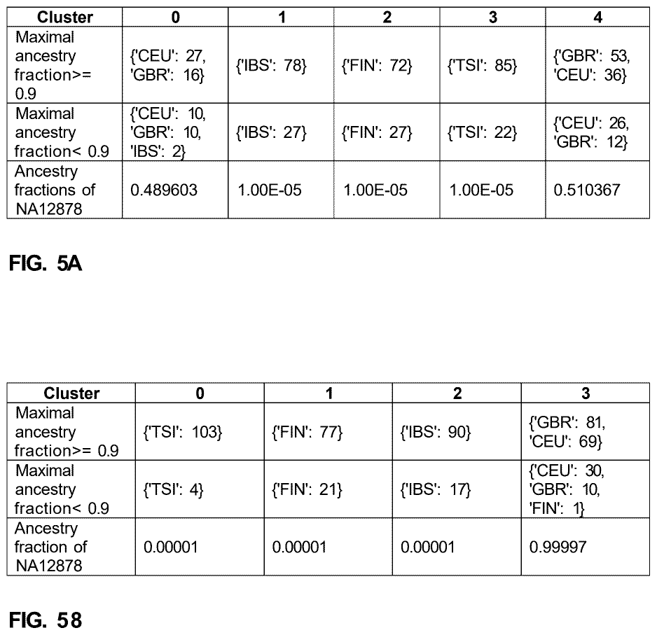

One example illustrating that applying a clustering technique to genomic data may better identify subpopulations of people than by simply relying on self-reported geographic locations is described below with reference to FIGS. 5A and 5B. To generate this example, the inventors applied the ADMIXTURE software tool to the European (EUR) dataset from the 1000 Genomes project to identify subpopulations. The EUR dataset includes 503 individuals from five self-reported subpopulations (CEU, IBS, FIN, TSI, and GBR, defined above). Genotypes for these 503 individuals at 1,183,809 allele sites were identified and used to cluster the genomic data using the ADMIXTURE software tool. Initially, the clustering technique was used to cluster the data into five clusters (since there are five self-reported subpopulations in the EUR dataset). As shown in the table of FIG. 5A, this yields three high quality clusters corresponding to the Iberian (IBS), Finnish (FIN), and Italian (TSI) groups. However, the difference between last two clusters are less pronounced, and appear to include members from both the British (GBR) and Central Europeans from Utah (CEU) groups.

Calculating the genetic distance between all pairs of the five subpopulations reveals that the CEU and GBR groups are closely linked, suggesting a high degree of mixture between the two. As shown in the table of FIG. 5B, running ADMIXTURE again allowing for only four clusters yields higher quality clusters than using the self-reported geographic locations. In the four resulting clusters, the CEU and GBR subpopulations are merged into a single cluster.

Accordingly, in some embodiments, subpopulations of people may be identified by clustering genomic data of people based on genotypes of the individuals at a set of allele sites. In other embodiments, however, subpopulations may be identified based on external data (e.g., self-reported geographic locations) and/or may be obtained from another source (e.g., the 1000 Genomes project or results of another analysis performed prior to the execution of process 400).

Regardless of the manner in which subpopulations of people are identified, each of the identified subpopulations may be associated with respective genomic data. The genomic data for a subpopulation may indicate the genotypes of people in that subpopulation for a set of allele sites (e.g., the sites used for clustering all the genomic data to obtain the clusters corresponding to the identified subpopulations). At act 404, these genomic data may be analyzed to obtain sub-population-specific variant occurrence frequencies for each of the plurality of subpopulations identified at act 402. This may be done in any suitable way, for example, by counting the number of times a particular variant occurs at each of the allele sites (used for identifying the subpopulations) within a subpopulation. In some embodiments, the population-specific variant occurrence frequencies may be output by the software tool used to cluster genomic data to identify the subpopulations (e.g., the ADMIXTURE tool).

At the conclusion of act 404, subpopulation-specific variant occurrence frequencies will have been obtained for each of the plurality of subpopulations identified at act 402. However, in some embodiments, before these occurrence frequencies are used to generate a model for identifying the subpopulation(s) to which an individual likely belongs, the subpopulation-specific variant occurrence frequencies are refined at act 406.

As described above, subpopulation-specific variant occurrence frequencies for a particular subpopulation may be obtained by calculating variant statistics for all people in the sub-population for each of multiple allele sites. At act 406, the variant occurrence frequencies are refined by: (1) identifying a subset of all the people in the subpopulation; (2) identifying a subset of the multiple allele sites; and (3) computing the variant statistics for the subset of people at the subset of allele sites to obtain a set of refined subpopulation-specific variant occurrence frequencies.

With regard to the first refinement, the inventors have appreciated that among people in a subpopulation, some individuals are more likely to be representative of the subpopulation than other individuals. For example, individual A with mixed ancestry (e.g., both Bengali and Gujarati ancestry) and individual B not having a mixed ancestry (e.g., only Bengali ancestry) may be both assigned to a cluster representing a Bengali subpopulation. As between these two individuals, individual B may have a higher probability of belonging to the Bengali cluster (e.g., 0.9) than individual A because individual A may have large probabilities of belonging to the Bengali cluster (e.g., 0.5) and to the Gujarati cluster (e.g., 0.4). Accordingly, in some embodiments, a subset of people in a subpopulation is identified to include only those people that have at least a threshold probability (e.g., at least 0.6, at least 0.7, at least 0.8, at least 0.9, at least 0.95, etc.) of being in the subpopulation. Such probabilities may be determined in any suitable way and, in some embodiments, may be determined by the software tool used to cluster genomic data to identify the subpopulations (e.g., the ADMIXTURE tool).

With regard to the second refinement, the inventors have appreciated that some of the multiple allele sites may be non-informative for distinguishing among subpopulations in that knowing the genotype of a particular individual at the non-informative allele site would not help determine the subpopulation(s) to which the individual likely belongs. In other words, the frequency of variant occurrence at non-informative sites may not differ significantly across different subpopulations. Accordingly, in some embodiments, a subset of the multiple allele sites is selected (the sites in this subset may be considered to be “informative”) by identifying sites having a difference in the frequency of variant occurrence between different subpopulations. Such a difference may be measured by comparing allele frequency distributions for the same allele site across different subpopulations, for example, by using a chi-squared test for independence. For example, the subset of the multiple allele sites may be obtained by: (1) creating a vector of genotype counts for each subpopulation for each allele site; (2) between each pair of subpopulations and for each allele site, calculating a chi-squared test of independence; and (3) selecting only those allele sites for which the chi-squared test of independence produces a p-value of less than a threshold value (e.g., less than 0.05, less than 0.01, 0.001, etc.) for at least one pair of subpopulations. A small p-value indicates a difference between the subpopulation-specific variant occurrence frequencies at that allele site. In some embodiments, the results of the chi-squared test for each site may be organized in a respective square NxN matrix, where N is a positive integer representing the number of subpopulations. The entry (i, j) of the matrix (where i ≠j) may store the result of the chi-squared test between population i and population j for that site.

After the subset of people and the subset of allele sites are selected at act 406, the subpopulation-specific variant occurrence frequencies may be recomputed for the subset of people at the subset of allele sites to obtain a set of refined subpopulation-specific variant occurrence frequencies.

Next, process 400 proceeds to act 408, where a model for identifying subpopulations to which the individual likely belongs is generated. The model may specify the refined subpopulation-specific variant occurrence frequencies at the subset of allele sites identified at act 406. Genotyping an individual for at least some of the subset of these informative allele sites may be used to determine the subpopulation(s) to which the individual likely belongs. The model may be generated in any suitable format. For example, the subpopulation-specific variant occurrence frequencies may be stored in an N x K matrix, where the integer N represents the number of different variants and the integer K represents the number of subpopulations. Each entry (n, k) in the NxK matrix may be a value between 0 and 1 indicating the frequency that the nth variant (e.g., a particular SNP at a particular informative site) occurs in the kth subpopulation.

In some embodiments, a multi-tiered approach to model building and genotyping may also be used. For example, one may generate models for the larger populations (e.g., AFR, EAS, EUR, SAS), and then for individuals in those populations, generate models for the subpopulations. Genotyping the first set of variants would thus comprise initially genotyping an individual for variants in the larger populations, identifying one or more larger populations for that individual, and then proceeding to genotype an individual for variants in corresponding subpopulations. Such an approach can improve the accuracy of genotyping, in that the models built for the subpopulations may have reduced noise and thus may be able to better distinguish individuals within that population.

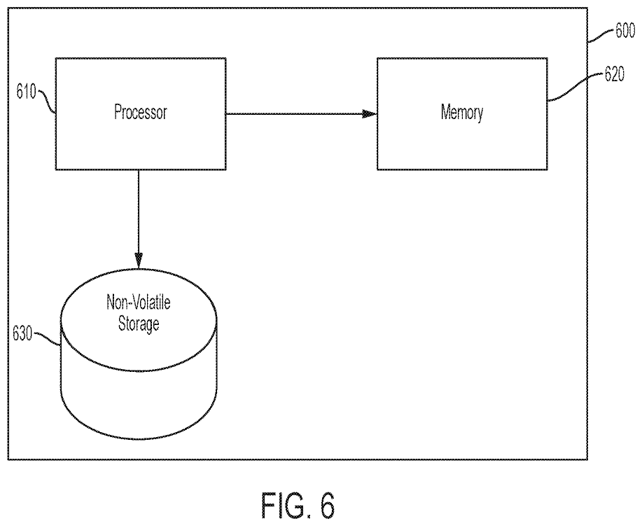

An illustrative implementation of a computer system 600 that may be used in connection with any of the embodiments of the disclosure provided herein is shown in FIG. 6. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner, as the aspects of the disclosure provided herein are not limited in this respect. To perform any of the functionality described herein, the processor 610 may execute one or more processor-executable instructions stored in one or more non-transitory computer-readable storage media (e.g., the memory 620), which may serve as non-transitory computer-readable storage media storing processor-executable instructions for execution by the processor 610.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art.

Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system, comprising:
at least one hardware processor; and
at least one non-transitory computer-readable storage medium storing processor-executable instructions that, when executed by the at least one hardware processor, cause the at least one hardware processor to perform:
obtaining a plurality of sequence reads for an individual;
obtaining information identifying a plurality of locations;
genotyping the plurality of sequence reads for the plurality of locations to obtain a first set of variants for the individual for at least some of the plurality of locations;
identifying a second set of variants associated with the first set of variants;
generating a personalized reference sequence construct using the second set of variants; and
aligning the plurality of sequence reads to the personalized reference sequence construct.

2-20. (canceled)
